(19) United States
(12) Patent Application Publication
(10) Pub. No.: US 2002/0047857 A1
(43) Pub. Date: Apr. 25, 2002

(54) Systems and methods for directed knowledge management using the DISHA platform

(76) Inventor: Srinivas Venkatram, Mumbai (IN)

Correspondence Address: Rashida A. Karmali, Suite 1000, 230 Park Avenue, New York, NY, 10169, US

(21) Appl. No.: 09/902,263

(22) Filed: Jul. 10, 2001

Related U.S. Application Data
(60) Provisional application No. 60/242,385, filed on Oct. 20, 2000.

(51) Int. Cl. G09G 5/12

(52) U.S. Cl. 345/700; 707/500.1

(57) ABSTRACT

The navigational structure comprises of at least three components including: 1) the user interface representing the seeker's frame reference as established by the seekers goals or specified outcomes, 2) a navigational structure providing a set of Access Maps choices which configure using a rule based, hierarchical, Boolean fuzzy logic or mapping method, and 3) a knowledge architecture specifying the inter-relationships between multiple seekers their outcomes and knowledge requirements.

### 1. FIELD OF THE INVENTION

The present invention relates to knowledge management systems and methods and more particularly to a rule based, hierarchical, fuzzy logic or other method based DISHA Platform that “orders” a complex, amorphous, functional knowledge system (e.g., a corporate organization) through the mechanism of role defined outcome architecture and visual structures called Access Maps. DISHA directs any knowledge user to the appropriate knowledge by enabling the user to simply specify his real life task outcomes within the framework of the architecture. DISHA achieves goal configured knowledge navigation, allowing users to accurately specify and retrieve purposive knowledge aimed to accomplish an outcome.

### 2. BACKGROUND OF THE INVENTION

The Internet has opened up the opportunity for on-line and low cost worldwide distribution of learning materials to users. Almost every single knowledge management initiative, whether in commercial, educational or personal context attempts at least in part to bring the knowledge base close to the actual tasks being carried out by the user. In other words, the goal is to seek “just-in-time knowledge”. A major challenge lies in making use of Internet technology to deliver highly customized knowledge to each individual user. For example, in the case of customized training, each user should be able to read, interact with and/or download materials, which address the user's needs as a function of the user's current level of learning. Existing systems for collecting and managing information have been inadequate to meet such needs because they do not provide for effective assessing, evaluating and updating of information or knowledge within an organization or system. In other words, existing systems do not adequately address the accrual of knowledge resulting from activity concerning the user's needs as determined from a variety of perspectives, which is an important aspect of succeeding in the electronic global environment.

As current information sources become larger and more complex to serve a variety of knowledge workers with particular information needs, providing knowledge workers within an organization with customized knowledge becomes increasingly important to the success of any organization. The problem lies in the ability of the knowledge workers within the organization to clearly specify their knowledge requirements and the resulting inability of knowledge managers to meaningfully package and provide the appropriate knowledge which may be in the form of documents, information bytes, video or sound, to the knowledge workers. According to the present invention, the problems and disadvantages with existing knowledge management systems and methods have been substantially eliminated.

### 3. SUMMARY OF THE INVENTION

The central notion of the Disha Platform is the concept of ‘goal configured knowledge navigation’. The paradigm allows any user of knowledge to encounter a knowledge base through visual structures which represent the user's ‘frame of reference’ in the form of navigational maps that describe his or her current area of work, knowledge needs, choice sets, etc. all organized around the user's real-life outcomes or goals. This is in direct contrast to all known methods of index searches, which essentially describe the knowledge base and its contents and not the user's real-life objectives (to which knowledge is a mere aid).

According to a broad aspect of a preferred embodiment of the invention, a plurality of navigational systems called collectively the DISHA Platform allows for meaningful specification of knowledge requirements within organizational, professional or personal context. The central notion of the DISHA Platform is one of Directing Information Systems Highway to Answers. The DISHA Platform is built on a general framework comprising of three components (i) a knowledge architecture, which is described in terms of user outcomes within the user's frame of reference, and the rules, which establish the relationships between and among outcomes. (An outcome is a clearly defined goal for the user, and will include both specific outcomes such as say, “solving a mathematical problem” to a broad level outcome such as “maximizing profits” or “minimizing time”. The knowledge architecture is embedded within an explicit navigational structure comprising of access maps. (ii) An Access Map is defined as a visual structure, which clearly defines the relationship between one outcome and other outcomes. The access map when represented visually on a computer, using common computer languages such as HTML or ASP, can act as a screen providing navigational choices for the user. The access map also provides information to the user relevant to the accomplishment of that outcome. The user therefore, has a choice to obtain information enabling him to accomplish the outcome, or go one step deeper and choose among a set of “subsidiary” outcomes that will help accomplish this outcome (iii). The outcomes themselves are grouped and organized into “outcome sets”. Each outcome set is derived by establishing a “Role Perspective” example—top level manager, lawyer etc. and describes the interaction between that role and the knowledge context being architected. Each “Role Perspective” has a unique entry point into the architecture. The “Role Player” also called the user, is presented with a set of outcomes which are most meaningful to that role perspective, within that context in the form of an access map. As the user makes choices, within the access map, further access maps open up, allowing the user to not only obtain information relevant to the accomplishment of that outcome, but also “zoom in” to a specific subsidiary outcome, and thereby navigate to other combinations of outcomes.

Thus, the paradigm allows a user to encounter a knowledge base through visual structures which represent the user's “frame of reference” in the form of navigational maps that describe the user's current area of work, knowledge needs or choice sets.

Specifically, the navigational structure comprises of at least three components including: 1) a set of entry user interfaces, representing the frames of reference of multiple seekers of knowledge, 2) a navigational structure comprising of access maps, which provide a set of choices configured using a rule based, hierarchical or boolean fuzzy logic or mapping method, (and access to information) and 3) an embedded knowledge architecture, that specifies the “Universe of Outcomes” within the knowledge space, and the co-relationships between outcomes and outcome sets, the relationships varying with multiple frames of reference (as derived from user roles).

In the preferred embodiment of the present invention, the knowledge management system uses generic families of visual structures, which perform specific tasks or organize specific bodies of knowledge for specific groups of users. The knowledge management systems and methods of the present invention provide a number of important technical advantages. According to the present invention, the DISHA Platform provides a system of built-in modularity comprising a plurality of interconnected navigational structures, each of which is focused on specific blocks such as people, tasks or processes, but which collectively develop into an organizational architecture. The DISHA Platform further provides a knowledge architecture that accurately reflects the knowledge and information requirements of various sub-components and sub-systems within an organization. The DISHA Platform also integrates the various retrieval and storage mechanisms into modular, visual structures that describe the work being done by the organization.

The preferred embodiment provides the Deliverables-Knowhow-Actionables (D-N-A) architecture useful for enabling individual knowledge workers in a company to get all the knowledge required to understand better and therefore execute day-to-day tasks. The D-N-A architecture of the invention comprises of three types of knowledge interfaces: 1) deliverables aggregation, 2) process knowledge interface, and 3) personal portals from which the user accesses the architecture. Each knowledge interface represents a distinct role perspective in the organization managing the company, managing processes and executing tasks. Each “Role Perspective”, leads to a set of user outcomes around which, knowledge is wrapped.

Thus, the novelty in DISHA is the notion of using a knowledge seeker's own goal or outcome environment as the basis of information choices, instead of using a description of the knowledge base. The present invention therefore provides “goal oriented intuitive seeking”. That is, the knowledge seeker merely specifies the goals he is seeking, and the choice of knowhow or process route needed to achieve that goal. This step then in and of itself, leads to approximate information retrieval through navigation led searches.

The navigation environment, as presented by access maps rests on the knowledge architecture, which is embedded within the rule bases which establish the linkages among access maps through the outcomes they represent. The knowledge architecture is the framework for access of knowledge related to work. The access maps also contain information which describe how different bodies of knowledge are integrated into a particular task.

The Knowledge Architecture of the present invention in and of itself is generic in nature for different groups of users. One embodiment described in detail below, the D-N-A system, is a generic architecture, which takes on a number of manifestations on the basis of industry/vertical, process or corporation.

The access maps of the present invention are of different types and are designed on the basis of typical information usage situations as organized around task goals, decision outcomes etc. For example, competitor radar is a type of map that can take on situation specific manifestations; but in all situations, performs the task of tying together, various information pieces such that the goal of appropriate benchmarking and identification of relative strengths and weaknesses may be met.

The DISHA Platform with the D-N-A generic architecture, as applied to a specific situation of the “Software Industry” is described in detail below.

Other important technical advantages are readily apparent to those skilled in the art from the following figures, detailed description of the invention and claims.

### 4. BRIEF DESCRIPTION OF THE FIGURES

For a complete understanding of the present invention and for further features and advantages thereof, reference is now made to the following description taken in conjunction with the accompanying drawings in which:

FIG. 1a illustrates the general model for the DISHA architecture, describing the various components of DISHA.

FIG. 1b illustrates the general structure of an Access Map.

FIG. 2 illustrates the general architecture for the DNA embodiment of DISHA.

FIGS. 3 to 10 describe the application of the DNA preferred embodiment as used in the software industry vertical. (This application of DISHA—DNA embodiment, has been specifically titled as TechDisha).

FIG. 3 illustrates the entry interface for firm manager of software industry.

FIG. 4 illustrates the view sets that are presented to the firm manager on choosing one of the outcomes in FIG. 3 viz., Multimedia Solutions.

FIG. 5 illustrates the Access Map that is presented to the user on selecting one of the view outcomes described above (products view—interactive CDs).

FIG. 6 illustrates the Access Map that is presented to the user on selecting one of the actionable sets relevant to “Making an Interactive CD”.

FIG. 7 illustrates another entry interface for the role perspective of task execution.

FIG. 8 illustrates the view set that is presented on selection of one of the role streams, i.e., “Multimedia Graphics and Design”.

FIG. 9 illustrates the actionables (outcomes) that are relevant to the selection made in FIG. 8, i.e., Image Designer.

FIG. 10a and 10b illustrate additional navigational options that allow movement from one set of outcomes to another. In FIG. 10a the role interaction map allows navigation from know-how outcomes to actionable sets, and in FIG. 10b the process relevance map allows navigation from actionable outcomes to know-how sets.

### 5. DESCRIPTION OF THE PREFERRED EMBODIMENT

A preferred embodiment of a system in accordance with the present invention is preferably practiced in the context of a personal computer such as an IBM compatible personal computer, Apple Macintosh computer or UNIX based workstation. A representative hardware environment is one which includes a typical hardware configuration of a workstation in accordance with a preferred embodiment having a central processing unit, such as a microprocessor, and a number of other units interconnected via a system bus. The workstation includes a Random Access Memory (RAM), Read Only Memory (ROM), an I/O adapter for connecting peripheral devices such as disk storage units to the bus, a user interface adapter for connecting a keyboard, a mouse, a speaker, a microphone, and/or other user interface devices such as a touch screen (not shown) to the bus, communication adapter for connecting the workstation to a communication network (e.g., a data processing network) and a display adapter for connecting the bus to a display device. The workstation typically has resident thereon an operating system such as the Microsoft Windows NT or Windows/95 Operating System (OS), the IBM OS/2 operating system, the MAC OS, or UNIX operating system. Those skilled in the art will appreciate that the present invention may also be implemented on platforms and operating systems other than those mentioned.

Almost every single knowledge management initiative, whether in commercial corporations, research units or university departments attempts at least in part to bring the knowledge base close to the actual task being carried out by people within that organization. This can be paraphrased as the ‘just-in-time knowledge’ goal.

The central difficulty in achieving this goal is the inability of the knowledge workers within the organization to clearly specify their knowledge requirements and the consequent inability of ‘knowledge managers’ to meaningfully ‘package’ and make available the appropriate documents, knowledge or information bytes to the knowledge worker within the organization. The present invention focuses on a mechanism that allows for meaningful specification of knowledge requirements within any organizational, professional or personal context. This mechanism (or set of mechanisms) can be called the ‘Disha Platform’.

Issues or operative criteria that have informed the development of this platform:

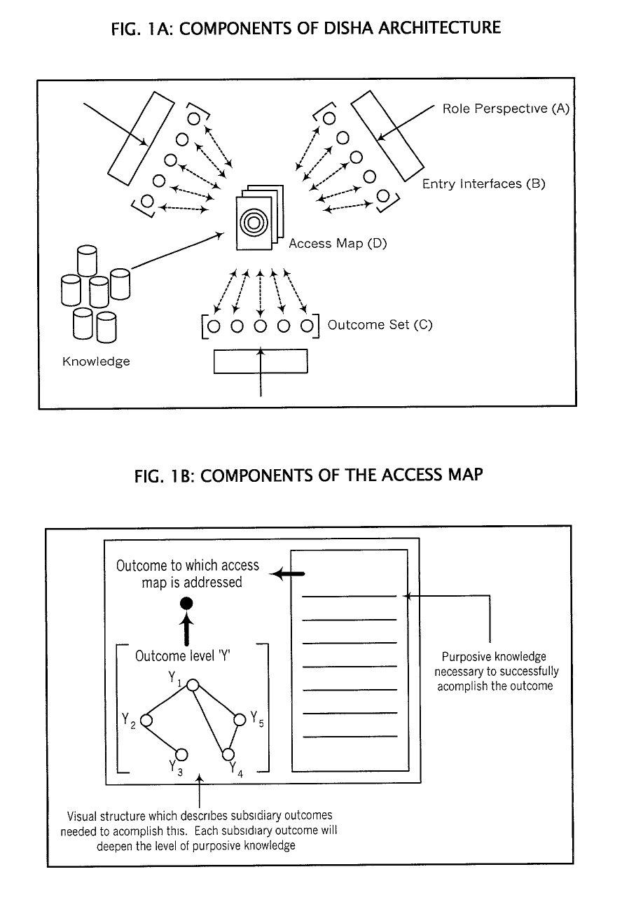

1. Ease of navigation—The central issue in developing appropriate navigation mechanism is the problem of ‘structuredness’. Conventional classification methods organize information very well, but often do not reflect the thought process of the user. On the other hand, indiscriminate use of hypertexting leads to a ‘deep forest’ situation where the user loses track not only of the information but also the logic of his thought process. To solve this problem Disha makes use of visual structures called Access Maps. Access Maps perform specific tasks of organizing specific bodies of knowledge for specific user groups around specified goals or outcomes, and further interlink each goal with sub-goals that need to be met in order to achieve the goal. (See FIGS. 1a & 1b).

2. Modularity—Organizations are interconnected units or sequences of work, all tuned in to a common goal or vision and usually engaged in delivering a common body of knowledge or physical products to the external world. Naturally, this has resulted in the development of numerous organizational structures, hierarchies, or modes of operation, and furthermore the need for numerous kinds of sophisticated management tools, processes and procedures. Beneath this apparent diversity there are a number of widely acknowledged and accepted sets of standard procedures and approaches, which together constitute either the professional practice or ‘management thought’. These procedures and approaches are learnt and applied by different types of ‘experts’ or task-focused individuals. Over time this specialization often results in an artificial division within the organization or practice group. Much of the developments in recent years have been directed towards building integrative mechanisms for organizational work, which at the same time allow for individual specialization and productivity.

Therefore, a knowledge specification or integration mechanism must necessarily address this problem. ‘Disha’ addresses this problem through the mechanism of built-in modularity. The modularity is achieved by isolating the outcomes of different ‘role players’ within the system and setting up the rules that govern the relationship between these outcomes. The visual maps that allow navigation across outcomes can be viewed as an interconnected system of navigational structures, which can be put together (like in a jigsaw), each of which is focused around specific people, task or processes but which together add up to what can be called the ‘organizational architecture’. Thus the organizational architecture with all its diversity of tasks, processes, inputs, outputs etc. becomes a simplified elegant “outcome architecture” that is common to all members of the organization community (since the reason an organization an organization is created is to achieve common outcomes).

3. Specification

Developing an ‘organizational architecture’ is not enough. This must translate into a ‘knowledge architecture’ that sits around the ‘organizational architecture’ and accurately reflects the knowledge and information requirements of the numerous sub-components and sub-systems within the organization. To achieve this, a number of distinct mechanisms are needed that will either send out retrieval requests to the knowledge base, or will be able to capture new knowledge (especially tacit knowledge or new knowledge generated in the course of work). Besides, there are other types of knowledge specification requirements, for example; information protocols (e.g. what kind of information is needed to perform a particular task), commitment information (e.g. who needs to do what task prior to a particular delivery), etc.

All this information and knowledge already exists in most organizations and professional practice groups. What Disha achieves is that it integrates the numerous retrieval and storage mechanisms into the modular, visual structures that describe the work being carried out by the organization. These visual structures which make knowledge purposive are organized around the outcomes and are described as learning structures in the co-pending U.S. Application entitled “Systems and Methods for Visual Optimal Ordered Knowledge Learning Structures” (Serial No. unassigned). Disha offers the enabling architecture to quickly select the appropriate learning structure. This has two important implications; (a) it solves the problem of appropriate knowledge specification by enabling individual knowledge workers to request knowledge in the context of their day-to-day work in an intuitive manner without having to formally formulate their request. Disha constructs a knowledge requirement on the basis of the user's ‘intuitive click’ and in order to be able to deliver the appropriate ‘knowledge packet’ to that user (b) it enables the knowledge managers to clearly understand the specific knowledge requirements within the organization at multiple levels of granularity and scope, and thereby build and maintain knowledge bases which are highly usable, productive and most important, non-redundant.

4. Knowledge delivery

A knowledge architecture, however detailed, has some inherent limitations. Just as a good building or floor design must still allow individual users to have as much operational flexibility as possible so also the knowledge architecture must ensure that users are able to build in a number of ‘second layer’ choices such as identifying only that knowledge that they do not already know or filtering out some knowledge on the basis of certain criteria or using specialized access tools for retrieving knowledge from specialized or different databases. Disha uses a number of new or unique knowledge delivery mechanisms in addition to commonly used approaches. For example, process or task level knowledge is (in addition to being visually represented) also delivered in the form of knowledge wrapped around ‘insights’. These insights themselves are in classes, such as performance insights, learning insights, etc., which have unique and replicable methods of construction. The unique feature is that all these delivery forms present knowledge in “purposive terms” i.e., meeting specific task goals or outcomes. (In contrast, a newspaper article for example, is not purposive and nor is it aimed at a specific task outcome).

A. Disha—Disha offers a formal method for achieving ‘goal configured knowledge usage’ by seekers of knowledge. The formal method is fundamentally a framework, which suggests that:

(a) any community or organization comprises of, and uses knowledge from multiple sources, and in multiple ways. Effectively managing this knowledge, organizing it, or navigating through it requires a method for ordering this complex, amorphous, functional knowledge system (e.g., a corporate organization), such that any knowledge user can navigate through the system or add and subtract relevant knowledge at the appropriate level of granularity, scope and usage.

(b) the DISHA architecture uses the goal or outcome hierarchies of each distinct role playing group within the organization or system as the key dimension on which the entire knowledge system is architected. This use of outcomes and goals as a means to “order” a knowledge or activity system, is a unique feature of DISHA. In the specific embodiment of DNA, the organization is viewed in terms of its outcomes as relevant to the three critical role groups in the organization, viz., the firm managers, the outcome configurators (or know-how managers), and the task executors. The outcomes in relation to these role groups are described in DNA as deliverables, know-how (e.g. processes, technologies, methods, etc.) accountables.

(c) these sets of outcomes (defined by different role groups), offer the possibility of viewing almost every task or process or organizational goal, from a multiplicity of perspectives which allows knowledge to be captured from different and differently meaningful points of view. Further, these outcomes together present a total knowledge universe within which all knowledge that is purposive (that is aimed at specifically meeting the organizations many outcomes), can be captured and elegantly retrieved.

To make this multiplicity of perspectives and elegant navigation feasible, Disha uses another unique feature—the Access Map. The access map is a specific or unique type of visual interface that essentially represents the micro knowledge universe for any outcome. This micro knowledge universe comprises of all knowledge that is purposively relevant to the outcome, which the access map addresses. This knowledge may be in the form of a knowledge cluster directly linked to the access map, or it may be encoded knowledge (that is knowledge implied in the subsidiary outcomes that together tie-up to make this outcome possible). The access map thus is a unique visual structure that allows a knowledge user to move through multiple levels of granularity and scope for dealing with a particular outcome, and in that sense is a portal for that outcome.

The combination of outcomes and access maps are many. A single outcome may lead to a single access map (i.e., one body of knowledge). A single outcome may also lead to multiple access maps (i.e., multiple bodies of knowledge relevant to multiple contributors to that outcome). In such a case, each access map is distinct and performs the role of organizing a different body of knowledge around the same outcome. For example, a single negotiation may involve multiple contributors such as finance, legal, marketing, etc., each of whom draw upon a distinct body of knowledge but purposively tied together to meet the outcome of a successful negotiation. In this example, a single outcome would have multiple access maps leading out to individual outcomes for each of the professionals involved, and from there on, a further increasingly granular and specific search for knowledge.

Any one professional associated with the negotiation described above could be similarly associated with multiple outcomes and will therefore have a common set of personal outcomes (actionables), that tie-up to multiple deliverables, through multiple know-how routes (consulting, drafting, discussing, etc.)

In this example, the knowledge architecture must capture the multiplicity of perspectives, scope, and granularity of knowledge in each situation, meaningfully and accurately. This goal is uniquely achieved by the DISHA architecture, which proves to be the “ordering algorithm” for all knowledge systems.

Referring to the figures, FIG. 1a illustrates the general model for the DISHA architecture, describing the various components of DISHA, which are a set of role perspectives (A), which establish the “points of view” of various users of the knowledge system, a set of entry interfaces (B), which describe each role's primary goals, a set of outcomes or goals (C), which are meaningfully defined in relation to each role perspective”, these outcomes are “embedded” within the visual structures described in the entry interfaces and access maps, a set of Access Maps (D), which describe the relationships between various outcomes and outcome sets and also, the knowledge (E) appropriate to each outcome (as outcomes become more specific, knowledge described by Access Maps also becomes more specific).

FIG. 1b illustrates the general structure of an Access Map comprising of three components—(1) the outcome being addressed by the map, (2) the knowledge necessary for successfully accomplishing that outcome (this knowledge would be at a broad level), and (3) the visual structures which tie-up and configure the subsidiary outcomes in order to accomplish this outcome. Each of these outcomes will contain further knowledge at a deeper level of granularity.

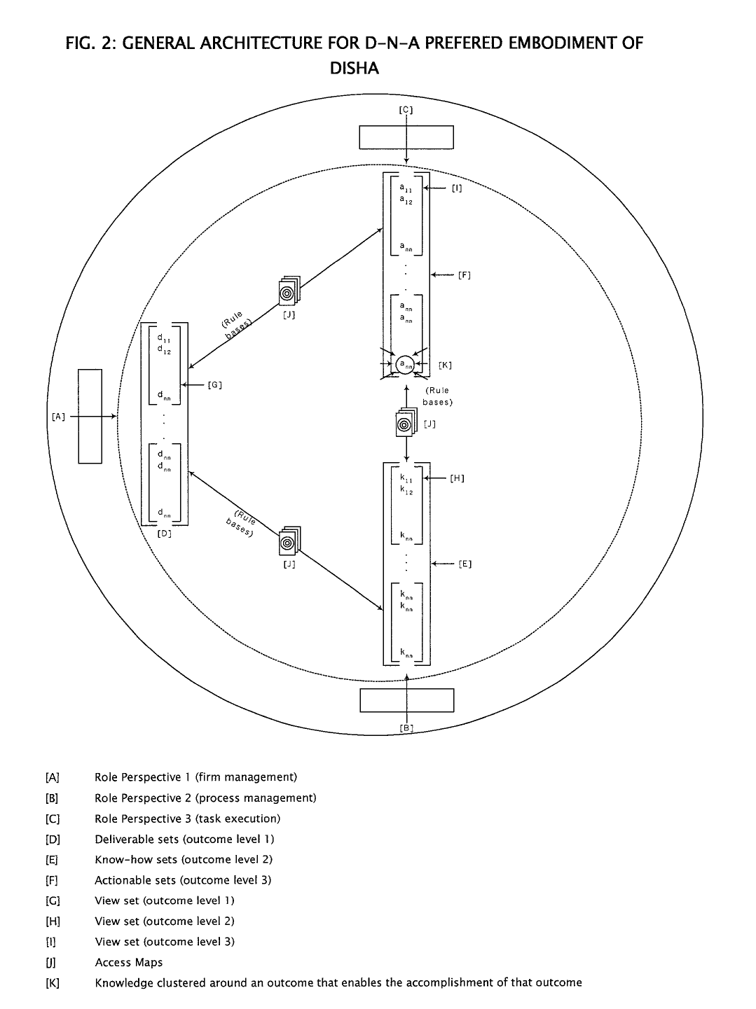

FIG. 2 illustrates the general architecture for the DNA embodiment of DISHA, comprising of three role perspectives of firm management (A), process management (B), and task execution (C); the outcome sets for each perspective described as deliverable sets (D), know-how sets (E), and actionable sets (F); the subsets within each of the outcomes sets described as view sets within deliverables, know-how and actionable sets (G, H, I), and the Access Maps (J); and the knowledge organized around each outcome, such that the user can meaningfully and effectively use that knowledge to achieve that outcome (K).

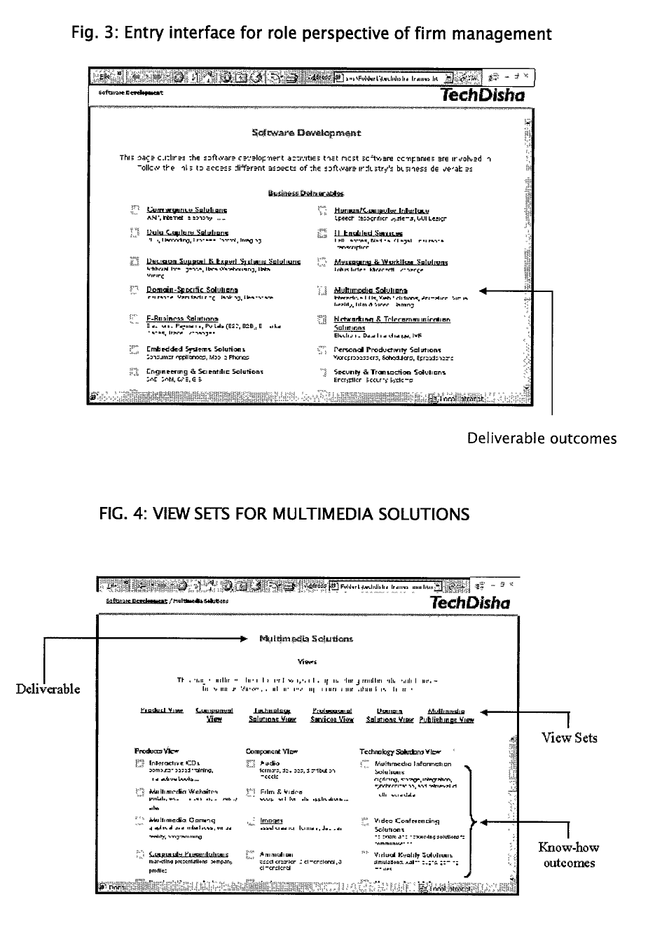

FIGS. 3 to 10 describe the application of the DNA preferred embodiment as used in the software industry vertical. (This application of DISHA—DNA embodiment, has been specifically titled as TechDisha).

FIG. 3 illustrates the entry interface for firm manager of software industry. The interface presents the list of business deliverables (outcomes as relevant to a firm manager, described in terms of ‘business products’—IT enabled services, E-business solutions, etc.)

FIG. 4 illustrates the view sets that are presented to the firm manager on choosing one of the outcomes in FIG. 3 viz., Multimedia Solutions. The view sets describe the outcomes presented in the previous screen in greater detail. Each set is distinct from others and organized around different “know-how routes” to the same outcome. (Each “know-how route” is relevant to different practioners, e.g., financial view, legal view, market view, customer view, investor view, etc.)

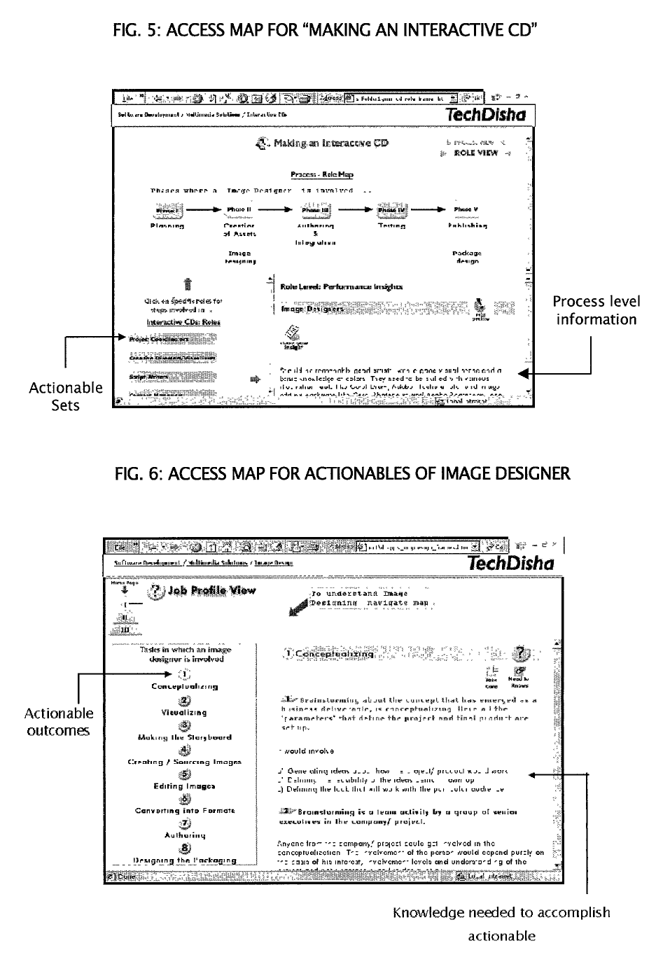

FIG. 5 illustrates the Access Map that is presented to the user on selecting one of the view outcomes described above (products view—interactive CDs). The Access Map “Making an interactive CD” describes the outcome set relevant to managing that specific process. FIG. 5 also contains a list of roles, which provide the user navigation access to the set of actionables. The figure also illustrates the presentation of process level information to the user.

FIG. 6 illustrates the Access Map that is presented to the user on selecting one of the actionable sets relevant to “Making an Interactive CD”, i.e., actionables organized around functional contributions—in this case, image designer. FIG. 6 also illustrates knowledge organized around these actionables such that the actionables may be executed optimally.

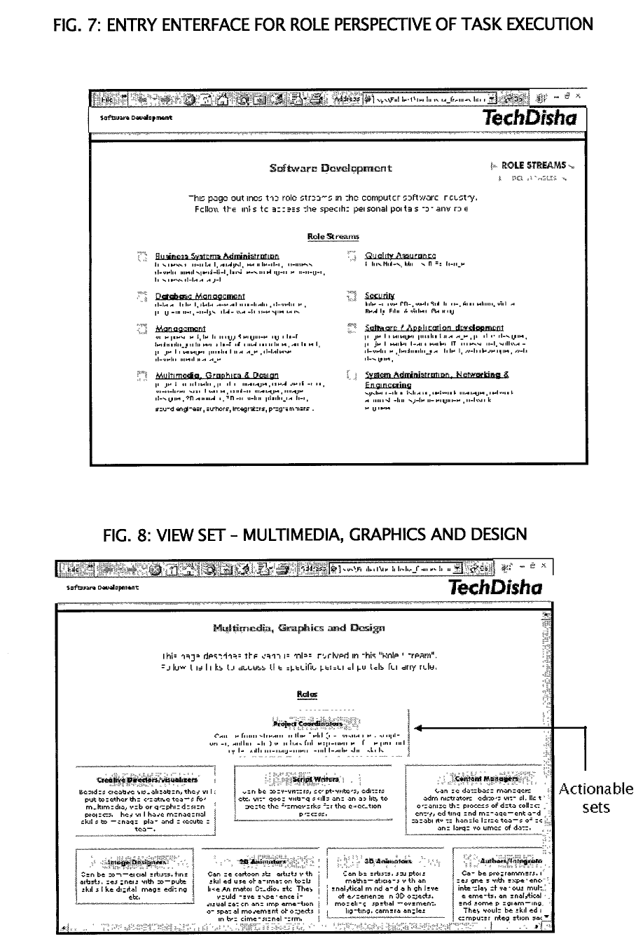

FIG. 7 illustrates another entry interface for the role perspective of task execution. The figure describes the set of role streams within the software industry. This represents the high level outcomes for all those playing task executor role, i.e., a role stream. A role stream is a sequence of roles increasing in hierarchical standing and responsibility levels.

FIG. 8 illustrates the view set that is presented on selected on selection of one of the role streams, i.e., “Multimedia Graphics and Design”.

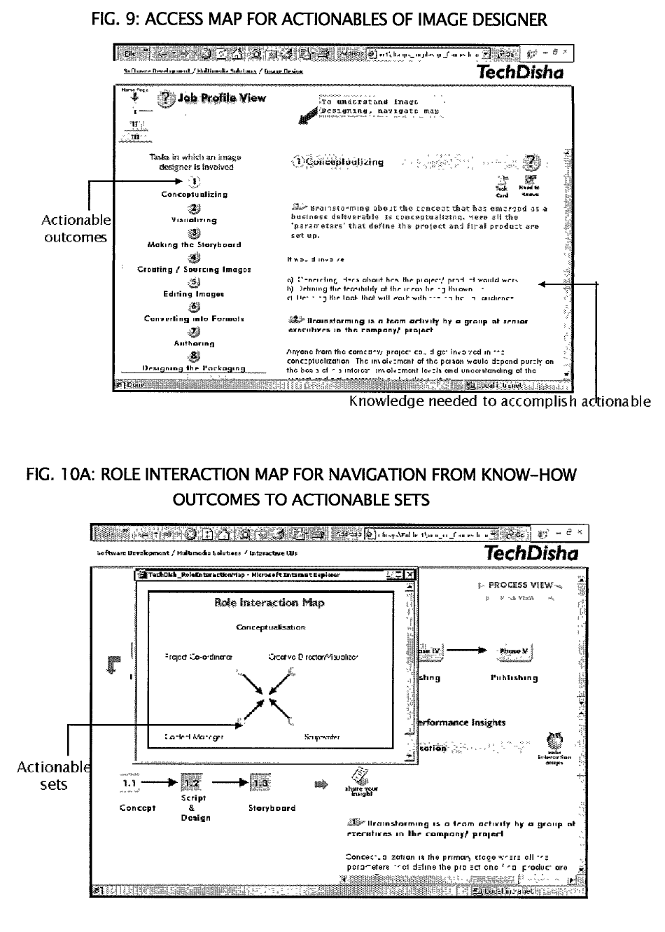

FIG. 9 illustrates the actionables (outcomes) that are relevant to the selection made in FIG. 8, i.e., Image Designer. This is the same figure as FIG. 6 and has been repeated here to illustrate the multiple pathways from different user perspectives to the same outcomes.

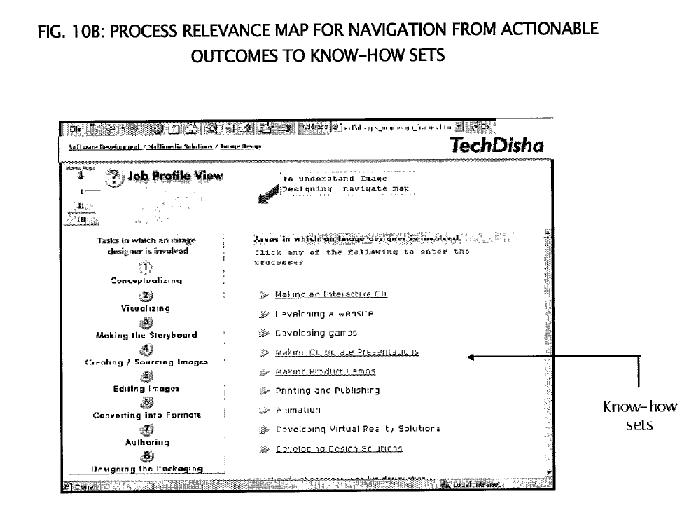

FIG. 10a and 10b illustrate additional navigational options that allow movement from one set of outcomes to another. In FIG. 10a the role interaction map allows navigation from know-how outcomes to actionable sets, and in FIG. 10b the process relevance map allows navigation from actionable outcomes to know-how sets.

The present invention is not to be limited in scope by the embodiment disclosed in the example which is intended as an illustration of one aspect of the invention and any methods and devices which are functionally equivalent are within the scope of the invention. Indeed various modifications of the invention in addition to those shown and described herein will become apparent to those skilled in the art from the foregoing description.

What is claimed is:

1. A user goal oriented knowledge architecture and navigational system for real-time determination and submission of specific knowledge needs of a knowledge seeker, said system comprising:
a) a knowledge architecture including a plurality of bodies of knowledge classified on basis of outcomes or task goals of the knowledge seeker,
b) a series of Access Maps which connect the different bodies of knowledge, and upon request for specific knowledge, or task, said maps integrate the different knowledge bodies and access knowledge for the particular task.

2. A user goal oriented knowledge architecture and navigational system for real-time determination and submission of specific knowledge needs of knowledge seeker, the system comprising:
a) means of entry interfaces which establish knowledge seekers on the basis of their role or point of view;
b) means of Access Maps represented as a Direct Information Systems Highway to Answers (DISHA);
c) means of establishing and setting up relationships between and among the outcomes or goals sought by the knowledge seeker, and among groups of knowledge seekers.;
d) means of describing each outcome sought by knowledge seekers and its inter-relationship with other outcomes, and with relevant knowledge;
e) means of visual structures in the form of navigational maps that define the knowledge seekers' current frame of reference;
f) means of evaluating the intuitive goal choices of the knowledge seeker to submit the seekers knowledge needs; and
g) means for delivering just in time knowledge to the knowledge seekers.

3. An Access Map comprising:
a) an outcome being addressed by the map;
b) knowledge necessary for successfully accomplishing that outcome; and
c) visual structures which tie-up and configure the subsidiary outcomes in order to accomplish this outcome.

4. A D-N-A architecture of a user goal oriented knowledge architecture and navigational system for determining and submitting the knowledge requirements of a seeker, the system comprising:
a) three role perspectives of firm management, know-how management, and task execution;
b) outcome sets for each perspective described as deliverable sets, know-how sets, and actionable sets;
c) subsets within each of the outcomes sets described as view sets within deliverables, know-how and actionable sets;
d) Access Maps; and
e) knowledge organized around each outcome, such that the user can meaningfully and effectively use that knowledge to achieve that outcome

5. The D-N-A architecture according to claim 4, the system comprising:
a) a set of deliverable maps arranged in a layer;
b) a set of process knowledge interfaces arranged in a layer;
c) a set of actionable maps arranged in a layer;
d) a set of entry interfaces to each layer and to the totality of the system;
e) means of collecting data on deliverables, actionables, and know-how, and the inter-relationships between them;
f) means of representing the said data in the form of appropriate visual structures that describe the above; and
g) means of presenting the said maps of a), b), c), or d), and data and visual structures of e) or f), to the knowledge seekers, and thereby submitting appropriate knowledge and further navigational choices

6. The D-N-A architecture according to claim 4, wherein the deliverable layer aggregates all the outcomes sought by a corporation,
said deliverables being further specified by outcomes defined by multiple perspectives including component view, technology view, and product view;
said deliverables represented by Access Maps of type deliverable maps;
said interface further including mechanisms for knowledge retrieval, knowledge capture or knowledge delivery; and
said mechanisms including inter-related requirements of seekers within a deliverable.

7. The D-N-A architecture according to claim 4, wherein the know-how layer aggregates all the outcomes sought at the know-how level by a corporation,
said know-how outcomes being further specified by outcomes defined by multiple perspectives;
said know-how outcomes represented by Access Maps of type know-how maps;
said interface further including mechanisms for knowledge retrieval, knowledge capture or knowledge delivery; and
said mechanisms including inter-related requirements of seekers within a process.

8. The D-N-A architecture according to claim 4, wherein the actionable layer comprises a plurality of individual portals, each of said individual portals being dedicated to an individual in an organization, thereby configuring said individual's needs.

9. The D-N-A architecture according to claim 4, wherein said actionable layer aggregates all the outcomes sought by each individual;
said actionables being further specified by outcomes defined by multiple perspectives including career view, job profile, view and productivity view;
said deliverables represented by Access Maps of type actionable maps;
said interface further including mechanisms for knowledge retrieval, knowledge capture or knowledge delivery; and
said mechanisms including inter-related requirements of seekers within a set of actionables.

10. A method of seeking knowledge on the basis of a seeker's specified goals or outcomes, said method comprising of:
specifying the various goals of different seekers of knowledge from the same knowledge base;
specifying the inter-relationships between the goals as a means for specifying navigation; and
specifying the purposive knowledge requirements of the seeker in terms of specified outcomes, and means for ongoing updation and real-time delivery of the knowledge base on a regular basis by using DISHA.

11. A method of meeting specific knowledge requirements of an organization by building and maintaining updated knowledge bases, said method including the use of a D-N-A architecture.
